(19) United States
(12) Patent Application Publication
(10) Pub. No.: US 2019/0016093 A1
(43) Pub. Date: Jan. 17, 2019

(54) PROCESS FOR GRAFTING BIOACTIVE POLYMERS ONTO METALLIC MATERIALS

(71) Applicants: Univ Paris XIII Paris-Nord Villetaneuse, Villetaneuse (FR); Centre National de la Recherche Scientifique (CNRS), Paris (FR)

(72) Inventors: Véronique Migonney, Eaubonne (FR); Jean-Sébastien Baumann, Epinay Sur Seine (FR); Céline Falentin-Daudre, Deuil La Barre (FR); Hamza Chouirfa, Epinay Sur Seine (FR)

(73) Assignees: Univ Paris XIII Paris-Nord Villetaneuse, Villetaneuse (FR); Centre National de la Recherche Scientifique (CNRS), Paris (FR)

(21) Appl. No.: 15/750,608

(22) PCT Filed: Aug. 8, 2016
(86) PCT No.: PCT/EP2016/068909

§ 371 Date: Feb. 6, 2018

(30) Foreign Application Priority Data
Aug. 7, 2015 (FR) 1557621

(51) Int. Cl. B32B 15/082; B32B 27/30; C08F 2/48; C08F 12/30; C23C 18/18; C08J 7/04; C08J 7/12

(52) U.S. Cl. CPC B32B 15/082; B32B 27/302; C08F 2/48; C22C 14/00; C23C 18/1889; C08J 7/04; C08J 7/123; C08F 12/30

(57) ABSTRACT

The present invention relates to a process for grafting polymers onto a metallic material, comprising the following steps: a) oxidation of the surface of the metallic material, resulting in an oxidized metallic material; b) grafting of a polymer at the surface of said oxidized metallic material by radical polymerization of a monomer, said radical polymerization comprising an initiation step and a propagation step, said initiation step being carried out by UV irradiation with a UV source diffusing a power at the surface of the material of greater than 72 mW·cm⁻², said UV irradiation being carried out for a duration greater than 15 minutes and less than 180 minutes, said process resulting in a grafted metallic material. The present invention also relates to the materials capable of being obtained by this process, and applications of the latter, in particular as articular or dental implants.

### FIELD OF THE INVENTION

The present invention concerns a process for grafting polymers onto a metallic material, the grafted metallic materials able to be obtained with this process and applications thereof. More specifically, the invention concerns a process for the direct grafting of polymers onto the surface of metallic materials.

### TECHNOLOGICAL BACKGROUND

The implanting of a joint or dental prosthesis into a bone site generates a cascade of tissue/implant reactions called “host response” which, if controlled, ultimately allows the obtaining of “osteointegration of the implant”, a process chiefly leading to the integration of the prosthesis in bone tissue through close bone tissue/prosthesis contact, and to minimisation of the thickness of fibrous tissue at the interface. If not, these reactions may require further surgical procedure and even removal of the prosthesis.

In fact, the implanted material is seen as a “foreign body” by the living system, triggering an inflammatory response possibly leading to fibrous encapsulation and thereby to rejection of the implant. In addition, when “fibro-inflammatory” tissue is produced around an implant (tissue not having any of the biological action or mechanical characteristics of bone tissue) the probability of aseptic loosening (detachment of the implant) or of an infection at the site of implantation becomes increased.

The prosthetic material appears to be a substrate of choice for the adhesion and colonisation of bacteria (sometimes with the formation of a bacterial “biofilm” resistant to antibiotics in particular) i.e. the initiating step of an infection possibly leading to septicaemia, endocarditis or osteomyelitis, particularly in the event of infections with staphylococci.

The process of osteointegration can therefore be affected by surgical technique and the presence of germs at the time of implantation, but also to a large extent by the physicochemical properties of the material such as surface topography, roughness or the chemical composition thereof.

To improve the osteointegration of implants, particularly metallic implants, “hydroxyapatite” coatings are currently used since they allow good bone anchoring whilst providing good mechanical performance within a relatively short time.

In addition, promising metallic or polymeric prosthetic materials have been developed that have their surface modified by grafting “bioactive polymers” intended to improve biointegration (in particular through a decrease in inflammatory response).

Several processes have been described to prepare these materials, processes that can be classified into two categories: processes using “indirect” grafting of the bioactive polymer, and “direct” grafting processes.

In the meaning of the present invention, an “indirect grafting process” includes a first functionalisation step of the surface of the metallic material with a molecule of low molecular weight that acts as anchor point for grafting the bioactive polymer, the polymer being either preformed or formed in situ via polymerisation in a subsequent step. As an example of indirect grafting, particular mention can be made of the process described in the article by Li et al. (Langmuir 2011, 27(8), 4848-4856). The process disclosed in this document involves a first grafting step via radical reaction of an olefin compound (preferably TMG-C10) with initiation via UV irradiation for a time of more than 2 h30. However, these compounds do not undergo any polymerisation reaction. They are bifunctional and their second functional group is used as anchor point to graft the polymer properly so-called. Therefore, the olefin compound (or coupler), once grafted, acts as anchor point in an “indirect” grafting process, where the polymer as such is added later via the second functional group.

In opposition thereto, a “direct grafting process” in the meaning of the invention is a process wherein the polymer is grafted directly onto the surface of the metallic material, without any intermediate molecule acting as anchor point for binding to the polymer. In other words, in a material obtained with a direct grafting process, there is no intermediate molecule between the surface of the material and the grafted bioactive polymer. Said process in particular is more economical, quicker and more efficient than an indirect grafting process. As an example, mention can be made of the process described in WO 2007/141460. This process comprises the following steps:
active donor species of free radicals are generated at the surface of the prosthetic material; and
the prosthetic material on which the active species were generated is placed in the presence of at least one monomer carrying a function allowing radical polymerisation, the radical polymerisation thereof in the absence of oxygen allowing formation of a bioactive polymer.

With said process it is possible in particular to produce prosthetic materials having a particularly high grafting rate of between 3 and 10 μg·cm⁻². However, the process in WO 2007/141460, which has recourse to a thermal initiation step of radical polymerisation, is particularly lengthy: a total preparation time of about 14-15 h (see in particular Example 1.4 in WO 2007/141460).

There is therefore a need for a process with which it is possible to obtain metallic materials having a high polymer grafting rate (in particular higher than 1.5 μg·cm⁻²) within a reasonable time e.g. less than 2 h30.

### SUMMARY OF THE INVENTION

The Inventors have therefore developed a process for grafting polymers onto a metallic material leading to high grafting rates, whilst spectacularly reducing (by a factor of more than 10) the total implementation time of the process according to WO 2007/141460.

More particularly, the inventors have reduced the time needed to carry out the radical polymerisation step having recourse to an initiation step via UV irradiation, in particular using a specific range of irradiating power.

In a first aspect, the invention therefore concerns a process for grafting polymers, preferably bioactive polymers, onto a metallic material.

In a second aspect, the invention concerns the metallic materials able to be obtained with said process.

In another aspect, the invention concerns the metallic implants manufactured from the metallic materials able to be obtained with the process of the invention.

In a last aspect, the present invention concerns the implants of the invention for use thereof for joint or tooth replacement, via surgery in particular.

### Definitions

Unless otherwise indicated, in the present description the subscripts m, n, p, q, are integers.

By “metallic material” in the meaning of the present invention is meant a material essentially composed of metal or a material having a surface essentially composed of metal. When the material is not essentially composed of metal, the thickness of the surface essentially composed of metal is preferably greater than 1 μm, more preferably greater than 10 μm.

By “alloy” in the meaning of the present invention is meant a material composed of a combination of a metal element with one or more other chemical elements. Preferably, all the chemical elements forming the alloy are metals. For example, the titanium alloy of the invention may be a combination of titanium with vanadium and aluminium (e.g. TA6V4Al comprising 6% Vanadium and 4% aluminium). An alloy may comprise a metal in combination with a chemical element representing up to 45% by weight of the alloy. For example, a Ti-25Nb-3Fe alloy comprises up to 25% Niobium and 3% Iron, and a Ti-24.8Nb-40.7Zr alloy comprises up to 24.8% Niobium and 40.7% Zirconium. An alloy may be the combination of numerous metal elements e.g. Ti-10.1Ta-1.7Nb-1.6Zr which is a combination of 4 different elements.

By “material essentially composed of X” in the meaning of the present invention is meant a material solely comprising X, X possibly being a metal element or an alloy, and optionally traces of other constituents. Therefore, a material essentially composed of X comprises at least 95% by weight, preferably at least 97% by weight of X, optionally in combination with oxygen, relative to the total weight of the material. It is effectively understood that a metallic material may comprise a native oxidation layer on the surface thereof. Therefore, a metallic material essentially composed of X comprises at most 5% and preferably at most 3% by weight of an element differing from oxygen and X, relative to the total weight of the material.

By “prosthetic material” in the meaning of the present invention is meant a material that can be used to manufacture a medical implant such as a prosthesis, in particular a hip prosthesis or dental implant. Preferably, the prosthetic material of the invention is essentially composed of metal.

By “pure compound” in the meaning of the present invention is meant that the compound has 100% purity. By “essentially pure compound” in the meaning of the present invention is meant that the compound is used as such without being mixed with another compound, in particular it is not placed in solution. An “essentially pure” compound can nevertheless contain up to 5% by weight (preferably less than 3%) of impurities relative to the total weight of the compound. Therefore, a monomer such as acrylic acid of commercial technical grade is an essentially pure compound.

By “bioactive polymer” in the meaning of the present invention is meant a polymer allowing improved osteointegration of the metallic material, preferably prosthetic material on which it is grafted. Preferably, a bioactive polymer is particularly capable of guiding the eukaryote and/or prokaryote cell responses towards the integration site of the prosthetic implant manufactured from a metallic material able to be obtained according to the process of the present invention, and to prevent the development of an infection. Said polymer preferably comprises ionic groups. More preferably, the bioactive polymer comprises phosphonate, carboxylate and/or sulfonate groups.

The contact angle of a material is measured using methods well known to persons skilled in the art. For example, a contact angle measuring method can use a drop of water deposited on the surface of the material (oxidized metallic material or grafted metallic material) measured with KRUSS: DSA100 apparatus providing information on changes in the hydrophilic or hydrophobic nature of the surface.

In the meaning of the present invention, an olefin is a monomer comprising at least one non-aromatic, carbon-carbon unsaturation (double carbon-carbon bond C═C, or triple bond C≡C), preferably a double bond. By monomers having at least one non-aromatic carbon-carbon unsaturation according to the invention is meant monomers having one or two, preferably one, double or triple bond, advantageously a double bond and more particularly the unit CH₂═CH—.

In the present invention, the acronym “UV” is synonymous of ultraviolet. Therefore, when the term “UV irradiation” is used it signifies “irradiation with ultraviolet rays”.

By “radical polymerisation” is meant chain polymerisation involving radicals as active species. It comprises steps of initiation, propagation, termination and optionally chain transfer.

At the initiation step, a radical is formed derived from the initiator on the first monomer unit (in this example an olefin monomer):

X.+CH₂═CHR→X—CH₂—HC.R.

Said initiation step can advantageously be performed without thermal heating in addition to UV irradiation.

Propagation is the main step of radical polymerisation. It is at this step that the polymeric chain is formed from the metal surface by successive additions of monomer units on the growing chain.

The number of occurrences of the propagation reaction governs the degree of polymerisation by number of the formed chain and hence the molar mass of the formed polymer.

X—(CH₂—CHR)ₙ—CH₂—HC*R+CH₂═CHR→X—(CH₂—CHR)ₙ₊₁—CH₂—HC*R.

The termination reactions are of several types. Termination may result from addition onto the growing chain of an initiator molecule, a solvent, an impurity contained in the medium etc. . . . . Other termination, recombination and disproportionation reactions involve two growing chains. In a recombination reaction, two chains reform a covalent bond:

X—(CH₂—CHR)ₙ—CH₂—HC*R+R*CH—CH₂—(CHR—CH₂)ₘ—X→X—(CH₂—CHR)ₙ—CH₂—HRC—CHR—CH₂—(CHR—CH₂)ₘ—X

In a disproportionation reaction, two chains give rise to a hydrogen transfer reaction followed by a recombination. The global result can be written:

X—(CH₂—CHR)ₙ—CH₂—HC*R+R*CH—CH₂—(CHR—CH₂)ₘ—X→X—(CH₂—CHR)ₙ—CH₂—CH₂R+CRH═CH—(CHR—CH₂)ₘ—X.

The relative proportion of these termination modes is essentially dependent on the type of monomer used, on the accessibility of the radical sites i.e. the steric hindrance of the active sites.

The grafting rate of the polymer (preferably bioactive polymer) on the grafted metallic material is expressed in μg·cm⁻². It is measured for example by colorimetric assay with toluidine blue when the polymer comprises sulfonate, carboxylate or phosphonate groups.

In the meaning of the present invention, by “acid” is meant an organic or mineral acid having a pKa in water of less than 3.

By “C₁-C₁₀alky” in the meaning of the present invention is meant a straight-chain or branched, saturated hydrocarbon chain having 1 to 10 carbon atoms. As an example of C₁-C₁₀ alkyl, mention can particularly be made of methyl, ethyl, propyl, n-butyl, s-butyl, tert-butyl, pentyl, isopentyl, n-hexyl. Preferably, the C₁-C₁₀ alkyl is C₁-C₄. Methyl and ethyl are particularly preferred.

By “heteroaryl” in the meaning of the present invention is meant an aromatic group having 5 to 10 cyclic atoms including one or more heteroatoms, advantageously 1 to 4 and more advantageously 1 or 2, such as sulfur, nitrogen or oxygen atoms for example, the other cyclic atoms being carbon atoms. Examples of heteroaryl groups are the furyl, thienyl, pyrrolyl, pyridinyl, pyrimidinyl, pyrazolyl, imidazolyl, triazolyl, tetrazolyl or indyl groups.

In the meaning of the present invention, by “controlled oxidation” is meant an oxidation step allowing the specific generation of —OOH hydroperoxide functions on the surface of the metallic material. Therefore, the controlled oxidation of the invention allows a result to be obtained that differs from non-controlled oxidation to which the metallic material could be subjected and leading to a natural oxidation layer that is essentially composed of OH functions the distribution and density of which are not homogeneous on the surface of the metallic material.

In the meaning of the present invention, by “absence of O₂” is meant an O₂ content of less than 1% by volume, preferably less than 0.5% by volume relative to the total volume of the gas under consideration.

In the meaning of the present invention, by “power per unit area” is meant the power of UV irradiation on the surface of the metallic material. It is notably dependent on the power of the lamp used and on the distance between the lamp and the sample. It can easily be measured by a skilled person e.g. using a radiometer with microprocessor (e.g. VLX-3W, VILBER LOURMAT). For measurement purposes, it is the stabilised power that is taken into consideration e.g. when the lamp has been switched on for 1 hour or longer.

### DETAILED DESCRIPTION OF THE INVENTION

Grafting Process

Therefore, the subject of the invention is a process for grafting polymers onto a metallic material, comprising the following steps:

a) oxidizing the surface of the metallic material, leading to an oxidized metallic material, and

b) grafting a polymer on the surface of said oxidized metal via radical polymerisation of a monomer, said radical polymerisation comprising an initiation step and a propagation step,

said initiation step being performed by UV irradiation with a UV source applying power onto the surface of the material higher than 72 mW, preferably of between 72 mW·cm⁻² and 20 W·cm⁻², more preferably between 72 mW·cm⁻² and 226 mW·cm⁻², further preferably between 91 mW·cm⁻² and 226 mW·cm⁻², and most preferably of about 162 mW·cm⁻²,

said UV irradiation being performed for a time of more than 15 minutes and less than 180 minutes, preferably of 120 minutes or less, more preferably of 90 minutes or less, said process leading to a grafted metallic material.

The process of the invention is a direct grafting process. Therefore, the grafting process of the invention is devoid of any step to graft an intermediate molecule or coupler between the metallic material and the grafted polymer.

Metallic Material

The metallic material of the invention is preferably a prosthetic material.

As examples of metallic, preferably prosthetic, materials mention can be made of titanium, aluminium, steel, chromium, cobalt, niobium, tantalum, vanadium, iridium, zirconium, gold materials and alloys thereof.

Metallic materials generally have a native oxidation layer on their surface that is spontaneously formed in the presence of air, comprising or essentially composed of M-OH groups having random density and distribution, M being an atom of one of the metals of the alloy, in particular an atom of a metal among those cited above.

The metallic material (preferably prosthetic) is preferably in titanium or a titanium alloy. Titanium is known for its biocompatibility properties.

Typically, a titanium material is essentially composed of titanium and/or titanium oxide. In all cases, titanium materials have a native oxidation layer on the surface, spontaneously formed in the presence of air, comprising Ti—OH groups having random density and distribution.

Advantageously the titanium alloy contains nickel, vanadium, aluminium, niobium and/or molybdenum, preferably it is an alloy of titanium, aluminium and vanadium, most preferably it is TiAl₆V₄.

Optional Polishing Step

The process of the invention may comprise a prior polishing step.

This step is preferably performed before the cleaning step described below.

The metallic material can therefore be polished by abrasion to limit the surface roughness of the material.

In one particular embodiment of the invention, the metallic materials are polished with grinding paper and preferably with different grinding papers of decreasing grit size. More specifically, mechanical polishing of the metallic materials can be obtained by means of an automatic arm mounted on a rotating polisher, using grinding paper of decreasing grit size. For example, grinding papers of grades 500 and then 1200 can be used.

Advantageously, the metallic material is also washed, preferably following after polishing, in particular by immersion in a solution of acetone, then in water and afterwards preferably dried.

Preferably, however, the process of the invention is devoid of any polishing step.

Roughness of the Metallic Material

Advantageously, the roughness of the metallic material used is greater than 0.2 μm, more preferably greater than 1 μm, and further preferably greater than 3 μm. Typically, the roughness is less than 20 μm.

Roughness is preferably measured by atomic force microscopy.

If the roughness of the starting metallic material is too high, the process then comprises a polishing step such as described above to obtain suitable roughness, in particular of between 0.2 μm and 20 μm, and preferably between 3 μm and 10 μm.

Cleaning Step

Advantageously, the process of the invention comprises a cleaning step, performed prior to the oxidation step to improve the efficacy thereof. If the process of the invention also comprises a polishing step, the cleaning step is performed between the polishing step and the oxidation step a).

Cleaning is advantageously chemical cleaning.

Chemical cleaning typically comprises placing the metallic material in contact with an aqueous acid solution. For example, the metallic material is immersed for a time t_{clean} in an aqueous acid solution.

The acid preferably has a pKa of between −2 and 3.

Preferably, time t_{clean} is between 0.5 and 10 minutes, more preferably between 0.5 and 2 minutes.

The aqueous acid solution used for the cleaning step is preferably an aqueous nitric acid solution (HNO₃) or an aqueous solution comprising a mixture of hydrofluoric and nitric acids (HF/HNO₃ mixture), preferably in HF/HNO₃ volume proportions of between 1:20 and 20:1.

Advantageously, the pH of the aqueous acid solution is between −1 and 3, more preferably between −1 and 1.

Therefore, advantageously, chemical cleaning comprises immersion of the metallic material in an aqueous acid solution of pH between −1 and 1 for a time t_{clean} of between 0.5 and 1 minute, the aqueous acid solution preferably being an aqueous solution comprising the HF/HNO₃ mixture.

Examples of embodiment of this cleaning step for materials in titanium or titanium alloy are notably described by Liu et al (Materials Science and Engineering. R47 (2004) 49-121) and Takeuchi et al (Biomaterials 24 (2003) 1821-1827).

When the process of the invention also comprises a cleaning step prior to the oxidation step, the oxidation step is preferably performed rapidly after cleaning. Therefore, the time between the end of the clearing step and the start of the oxidation step is advantageously less than 16 hours, preferably less than 12 hours, more preferably less than 6 hours and most preferably less than 3 hours.

Advantageously, the cleaning step also comprises washing (rinsing) of the cleaned material with water and in particular distilled water.

Oxidation (Step a)

In general, oxidation can be performed using any means for oxidizing metallic materials well known to persons skilled in the art, such as oxidation by treatment with a solution of hydrogen peroxide, or by means of a strong temperature or a combination of both techniques (Takemoto et al., 2004), anodic oxidation of titanium in an acetic acid solution or in a mixture of electrolytes containing magnesium ions (Sul et al., 2005), micro-arc oxidation on prostheses in titanium (Li et al., 2004).

The oxidation step a) advantageously allows an oxidized layer comprising hydroperoxide groups —OOH, to be provided in controlled manner on the surface of the metallic material.

Metallic materials, and in particular titanium or a titanium alloy, have a native oxidation layer having a content of M-OH functions that is not controlled (M being a metal atom). For these metallic materials, the oxidation step particularly allows the forming on the surface of metal hydroperoxides (M-OOH) the density of which can be controlled.

As a result, the oxidation step a) has a direct impact on the grafting rate of the polymer that is very high, typically between 1.5 and 10 μg·cm⁻². Therefore, if step a) of the process of the invention is omitted, the grafting rate will be greatly reduced in particular with metallic materials such as preferably prosthetic materials in titanium, aluminium or an alloy.

In addition, it appears that the oxidation layer allows preventing the migration of toxic metal ions, in particular when the process uses a titanium alloy of TiAl₆V₄ type (in this particular case, the toxic metal ions are vanadium and aluminium ions).

In a first embodiment, the oxidation step a) is carried out by chemical treatment: this embodiment shall hereafter be designated “oxidation via chemical route”. In particular, oxidation via chemical route is oxidation by contacting the metallic material with an oxidizing solution, H₂O₂ in particular, or oxidation by ozonizing. Oxidation via chemical route is obtained in particular by treating the material with an aqueous solution comprising an oxidant and an acid, preferably a mixture of H₂SO₄ and H₂O₂.

The contacting of the metallic material with the oxidizing solution (in particular a solution comprising H₂O₂) can be performed for example by pouring the oxidizing solution into a container containing the metallic material, or the metallic material can be immersed in a container containing the oxidizing solution.

If oxidation is conducted via chemical route by contacting the metallic material with an oxidizing solution, said oxidizing solution in in particular an acid/oxidant mixture, in particular H₂SO₄/H₂O₂. The acid is preferably an acid having a pKa (in water) of less than 3, more preferably having a pKa (in water) of less than 2. Advantageously, the acid is in an aqueous solution and selected from among hydrofluoric acid (HF), hydrochloric acid (HCl), sulfuric acid (H₂SO₄) and mixtures thereof, more preferably it is H₂SO₄.

The oxidant is preferably H₂O₂. Nevertheless, it can be replaced by ozone if ozonisation is used.

Therefore, preferably, in this embodiment via chemical treatment, the oxidation step a) is conducted with an aqueous H₂SO₄/H₂O₂ mixture.

The proportion of acid to H₂O₂ may vary to a large extent and it is within the reach of skilled persons to determine the most efficient ratio to arrive at a desired grafting rate. Preferably, the solution used is H₂SO₄/H₂O₂ (v/v) at 50:50 to oxidize the metallic material. The temperature applied is generally ambient temperature (20-30° C.), even a lower temperature (e.g. between 0 and 20° C.), the oxidation reaction possibly being exothermal.

By “acid/H₂O₂ mixture” is meant the simultaneous or sequential mixing of the acid solution and H₂O₂ solution. For example, either the two solutions are placed in contact simultaneously with the metallic material to be oxidized, or the metallic material is first contacted with the acid solution and the H₂O₂ solution is subsequently placed in contact with the metallic material.

In either case, persons skilled in the art are able to adapt the contact time of the metallic material with the oxidizing solution as a function of type of material (pure titanium or in alloy form . . . ), of the mode of chemical oxidation and the desired final grafting rate.

In the event of simultaneous acid/H₂O₂ mixing, the oxidation time is preferably 1 to 10 minutes, more preferably 3 to 6 minutes and further preferably the oxidation time is 4 minutes. Preferably, this oxidation time is applied to the oxidation of titanium or one of the alloys thereof in a solution of H₂SO₄/H₂O₂.

In the event of sequential mixing, the metallic material can be immersed in the acid solution for example for at least 10 seconds, preferably for at least 20 seconds, preferably for at least 30 seconds, more preferably for more than 50 seconds, preferably for more than 1 minute, preferably for more than 2 minutes, preferably for more than 3 minutes, preferably for more than 4 minutes. This time during which titanium or one of the alloys thereof is placed in the presence of H₂SO₄ may be much longer and for example may reach 30 minutes or more. However, in one preferred embodiment, the time during which the metallic material is placed in the presence of the acid solution is less than 5 minutes, after which time a decrease in grafting rate is observed. This procedure is particularly applied for oxidation of titanium or one of the alloys thereof advantageously placed in contact with a solution of H₂SO₄.

Similarly, the time during which the metallic material is placed in the presence of the H₂O₂ solution may also vary. Preferably, the metallic material, preferably titanium or one of the alloys thereof, is placed in contact with H₂O₂ for at least 10 seconds, preferably at least 20 seconds, preferably at least 30 seconds, preferably at least 40 seconds, preferably at least 50 seconds, preferably for at least 1 minute, preferably at least 2 minutes, preferably for 2 to 3 minutes, and most preferably for two minutes after adding the solution of H₂O₂. In one preferred embodiment, preference is given to action of H₂SO₄ on titanium or one of the alloys thereof for 1 minute, followed by action of H₂O₂ on titanium for 3 minutes.

Chemical oxidation by immersion of the metallic material in an oxidizing solution, in particular an acid/H₂O₂ mixture and preferably a mixture of H₂SO₄/H₂O₂, typically in a proportion of 50:50 (v/v), is particularly preferred.

In one preferred embodiment, oxidation step a) is performed by chemical treatment with a mixture of H₂SO₄ and H₂O₂, typically in a proportion of 50:50 (v/v).

In another embodiment, oxidation step a) is performed by anodic treatment (or anodization) or by ozonisation.

Typically, when using anodic treatment for oxidation, the metallic material is placed in contact with an acid electrolytic solution contained in an electrochemical cell comprising an electrode, through which an electrochemical current is passed, the metallic material acting as anode in the electrochemical cell. At the anode (metallic material) an oxidation reaction of the protons takes place as per the following equation: 2e⁻+2H⁺→H₂.

Advantageously the potential applied to the anode is between 10 and 250 V vs. a standard hydrogen electrode (SHE), preferably between 20 and 200 V vs SHE.

Also, advantageously the intensity applied at the anode is between 0.1 and 50 mA/cm², preferably between 1 and 50 mA/cm².

Preferably, the electrolytic solution comprises an acid having at least a pKa lower than 2.5, for example an acid having at least a pKa of between −10 and 2.5. For example, chromic acid can be used (chromic anodization), sulfuric acid (sulfuric anodization), orthophosphoric acid, oxalic acid or a mixture thereof. The acids can also be used in a mixture with an alcohol such as a methanol/NaNO₃ mixture. Preferably, however, the electrolytic solution comprises sulfuric acid (sulfuric anodization) or orthophosphoric acid, preferably orthophosphoric acid.

Regarding metallic materials, on a laboratory scale, it is preferred to implement oxidation step a) via chemical treatment, whilst on an industrial scale it is preferred that the oxidation step a) should be implemented via anodic treatment.

Monomers

The monomer used at step b), involved in radical polymerization carries a function allowing radical polymerisation. Preferably, said monomer is an olefin.

The structure of the monomers used in the present invention allows the formation of a polymer, preferably bioactive, on the surface of a metallic material. In particular, to improve the osteointegration and anti-bacterial properties of the materials cited above, the monomers used in the present process advantageously comprise a sulfonate and/or carboxylate and/or phosphonate group. Polymers carrying sulfonate and/or carboxylate and/or phosphonate ion groups promote the adherence, colonisation and differentiation of osteoblasts. In addition, polymers carrying sulfonate and/or phosphonate groups inhibit the adherence of bacterial strains, in particular Staphylococcus aureus and Staphylococcus epidermidis, these being the strains that are mostly involved in infections on prosthetic metallic materials.

Therefore, advantageously, the olefin is selected from among olefins of formula (I), (II) or (III):

CH₂═CR₁—(CH₂)ₙ—R′—C(O)OR (I),

CH₂═CR₁—(CH₂)ₘ—R′—S(O)₂OX (II),

CH₂═CR₁—(CH₂)ₚ—R′—P(O)O₂Y (III),
where,
R₁ is a hydrogen atom or C₁-C₁₀ alkyl, preferably a hydrogen atom,
n is between 0 and 6, preferably between 0 and 1,
R is a hydrogen atom, C₁-C₁₀ alkyl optionally substituted by a group among OH, COOH and PO₃H, an Ar group optionally substituted by a group among OH, COOH and PO₃H, Ar being a phenyl or heteroaryl group, preferably a phenyl group, or R is a hydrogen atom or a cation selected from among alkali or alkaline-earth metals, for example from among Na⁺, Ca²⁺, Zn²⁺ or Mg²⁺, preferably Na⁺ or Ca²⁺, preferably R is a hydrogen atom or a cation selected from among alkali or alkaline-earth metals for example from among Na⁺, Ca²⁺, Zn²⁺ or Mg²⁺, preferably Na⁺ or Ca²⁺,
m is between 0 and 6, preferably between 0 and 1;
R′ is a bond, C₁-C₁₀ alkyl optionally substituted by a group among OH, COOH and PO₃H, or R′ is a group among —C(O)—CR₂—OCR₃, Ar′, Ar′—O— or Ar′—C(O)NH—, Ar′ being a phenyl or heteroaryl group optionally substituted by a group OH, COOH or PO₃H, preferably a phenyl group optionally substituted by a group OH, COOH or PO₃H, and
R₂ and R₃ are each independently C₁-C₁₀ alkyl groups,
X is a hydrogen or one or more cations selected so as to obtain an electrically neutral species, in particular a cation selected from among alkali or alkaline-earth metals e.g. from among 2 Na⁺, Ca²⁺, Zn²⁺ or Mg²⁺, preferably 2 Na⁺ or Ca²⁺,
p is between 0 and 6, preferably between 0 and 1,
Y is a hydrogen or one or more cations selected so as to obtain an electrically neutral species, a cation selected from among alkali and alkaline-earth metals e.g. from among Na⁺, Ca²⁺, Zn²⁺ or Mg²⁺, preferably Na⁺ or Ca²⁺.

Among the olefins of formula (I), particular mention can be made of acrylic acid (AA), methacrylic acid (MA), ethacrylic acid (EA), the corresponding salts (in particular salts of alkali metals, preferably sodium) and mixtures thereof.

In one particular embodiment, the olefin of formula (III) is an olefin of formula (IV):

CH₂═CR₁—(CH₂)_{q}—P(O)O₂Y (IV)

where R₁ and Y are such as defined above, and q is between 0 and 6, preferably between 1 and 5, for example it is 2.

In the embodiments in which an olefin of formula (I) having a group R representing a C₁-C₁₀ alkyl optionally substituted by an OH group, the polymerisation step b) is preferably followed by a hydrolysis step of the ester function to release the corresponding acid, either in acid form or in salt form, preferably with a cation selected from among alkali or alkaline-earth metals e.g. from among Na⁺, Ca²⁺, Zn²⁺ or Mg²⁺, preferably Na⁺ or Ca²⁺.

Among the olefins of formula (II), those particularly preferred are the olefins in which R′ is a group among Ar, Ar—O— and Ar—C(O)NH—, preferably Ar, Ar being a phenyl or heteroaryl group, preferably a phenyl group.

Therefore, in one particular embodiment, the olefins of formula (II) are selected from among the olefins of formulas (V) and (VI):

CH₂═CR₁-Ph-S(O)₂OX (V),

CH₂═CR₁-Ph-CO—NH—S(O)₂OX (VI),

where X and R₁ are such as defined above, and Ph is a phenyl core, preferably substituted at positions 1 and 4.

Among the monomers of formula (II), (V) or (VI), particular mention can be made of N-(sodium phenylsulfonate) acrylamide (NaAS), N-(sodium phenylsulfonate) methacrylamide (NaMS), sodium styrene sulfonate (NaSS) and mixtures thereof. Preference is given to sodium styrene sulfonate.

Among the monomers of formula (III), particular mention can be made of vinylbenzylphosphonate (VBP) and ethyl 2-[4-(dihydroxyphosphoryl)-2-oxa-butyl]acrylate (MA154).

Therefore, advantageously the monomer in particular the olefin is selected from among sulfonates, phosphonates and/or carboxylates, preferably selected from among acrylic acid, methacrylic acid, methyl methacrylate (MMA), N-(sodium phenylsulfonate) acrylamide (NaAS), N-(sodium phenylsulfonate) methacrylamide (NaMS), sodium styrene sulfonate (NaSS), ethylene glycol methacrylate, methacrylate phosphate, methacryloyl-di-isopropylidene, vinylbenzylphosphonate (VBP), ethyl 2-[4-(dihydroxyphosphoryl)-2-oxa-butyl]acrylate (MA154), or mixtures thereof.

Grafting Via Radical Polymerisation (Step b)

In the present invention, the initiation step via UV irradiation allows the generation of —O. radicals. Therefore, the initiation step via UV irradiation consists of homolytic cleavage of the O—O bond of the hydroperoxide group (generated by means of oxidation step a)) or of the O—H bond of the hydroxide group (resulting from native oxidation of the material) present on the surface of the oxidized metallic material: —OOH→—O. or —OH→—O..

In particular, for a metallic material in titanium, the mechanism of this initiation step via UV irradiation can be represented as follows:

TiO—OH→TiO..

The initiation step can be performed prior to or concomitantly with the propagation step. At step b), the monomer(s) can be used either in solution, or pure or essentially pure. If the monomer(s) are used in solution, it is in an organic or aqueous solvent. Preferably it is an aqueous solution.

Advantageously, the concentration of monomer(s) in the solution is between 0.2 and 1 mol·L⁻¹, preferably between 0.3 and 1 mol·L⁻¹, for example 0.7 mol·L⁻¹. Preferably, the monomer(s) are used in an aqueous solution at a concentration of between 0.2 and 1 mol·L⁻¹, preferably between 0.3 and 1 mol·L⁻¹, for example 0.7 mol·L⁻¹.

Advantageously, said radical polymerisation is performed in the absence of oxygen. The presence of oxygen tends to inhibit radical polymerisation. Therefore, preferably step b) is performed in the absence of oxygen in an inert atmosphere in particular under argon, helium or nitrogen, advantageously in an argon atmosphere.

In one particular embodiment, grafting step b) comprises the following sub-steps:
b1) contacting the oxidized metallic material with said monomer in an aqueous solution;
b2) UV irradiation of the solution comprising said monomer and said oxidized metallic material, with a UV source applying power onto the surface of the material higher than 72 mW·cm⁻², preferably between 72 mW·cm⁻² and 20 W·cm⁻², preferably between 72 mW·cm⁻² and 226 mW·cm⁻², preferably between 91 mW·cm⁻² and 226 mW·cm⁻², most preferably of about 162 mW·cm⁻².

Therefore, in this embodiment, the initiation step is conducted concomitantly with propagation (step b2). The initiation and propagation steps therefore both take place at step b2).

The aqueous solution at step b1) containing said monomer advantageously further comprises an UV activator, preferably selected from among fluorescein and benzophenone.

In another embodiment, grafting step b) comprises the following sub-steps:
b1′) immersing the oxidized metallic material in the monomer, said monomer being essentially pure, leading to a monomer-impregnated oxidized metallic material;
b2′) UV irradiation of the monomer-coated oxidized metallic material with a UV source applying power onto the surface of the material higher than 72 mW·cm⁻², preferably between 72 mW·cm⁻² and 20 W·cm⁻² preferably between 72 mW·cm⁻² and 226 mW·cm⁻², preferably between 91 mW·cm⁻² and 226 mW·cm⁻², most preferably of about 162 mW·cm⁻².

Therefore, in this embodiment also, the initiation step is performed concomitantly with propagation (step b2′)). The initiation and propagation steps therefore both take place at step b2′).

Step b) comprises UV irradiation of the oxidized metallic material with a UV source advantageously having a wavelength of between 10 nm and 380 nm, preferably between 200 nm and 380 nm. For example, the UV source has a wavelength of 365 nm or 254 nm, preferably 365 nm.

One important irradiation parameter is power per unit area on the surface of the oxidized metallic material, which itself is a function of the power of the UV source, and of the distance d_{S-Mox} between the UV source and the oxidized metallic material. Preferably, the power of the UV source is between 50 and 400 W, more preferably between 150 and 200 W.

For example, when the power of the UV source is 200 W, the distance d_{S-Mox} may be between 5 and 30 cm, preferably between 5 and 20 cm.

In one particular embodiment, the distance d_{S-Mox} is 10 cm and the power per unit area of the UV source at 200 W is 162 mW/cm⁻².

Therefore, UV irradiation is preferably performed with a UV source applying power per unit area on the surface of the oxidized metallic material higher than 72 mW·cm⁻², preferably between 72 mW·cm⁻² and 20 W·cm⁻², preferably between 72 mW·cm⁻² and 226 mW·cm⁻², preferably between 91 mW·cm⁻² and 226 mW·cm⁻², most preferably of about 162 mW·cm⁻².

Another important parameter to be taken into account is the duration of UV irradiation t_{UV}. Persons skilled in the art will choose the time needed for irradiating the metallic material as a function of type of material, the polymer to be grafted and desired grafting density. Preferably the irradiation time is less than 180 minutes.

Advantageously, the irradiation time UV t_{UV} is less than 120 minutes. For example, the irradiation time UV t_{UV} is between more than 15 minutes and 120 minutes, more preferably between 30 minutes and 60 minutes, e.g. 60 minutes.

In one particular embodiment in which the metallic material is a material in titanium, the irradiation time UV t_{UV} is advantageously between more than 15 minutes and 120 minutes for a power per unit area preferably higher than 72 mW·cm⁻².

In one particular embodiment in which the metallic material is a material in a titanium alloy, the irradiation time UV t_{UV} is advantageously between more than 15 minutes and 120 minutes, with power per unit area preferably higher than 72 mW·cm⁻².

Advantageously, it therefore appears that the grafting rate of the oxidized metallic material at step b) is a function both of the UV irradiating power received by the oxidized metallic material, and of the power per unit area received by said material. Therefore, advantageously the power per unit area due to UV irradiation received by the oxidized material is between 72 and 226 mW/cm⁻², more preferably between 91 and 162 mW/cm⁻², and the total surface energy received by the, preferably prosthetic, oxidized metallic material from UV irradiation is between 194.4 and 1749.6 J·cm⁻², more preferably between 220 and 450 J·cm⁻².

The grafting step b) therefore leads to a grafted metallic material.

So-Called “Conditioning” Rinse and Wash Steps

The grafted metallic material is subjected to different rinses and washes in aqueous and/or aqueous saline solutions at ambient temperature or at 37° C. or at 60° C. The aqueous or aqueous saline solutions are distilled water, aqueous NaCl solutions at different concentrations, and/or a saline phosphate buffer solution (PBS or “Phosphate-buffered saline”).

Said step advantageously allows the grafted metallic material to be cleared of any non-grafted polymeric chain on the surface of said material. The grafted, rinsed metallic material obtained, once implanted, offers improved patient safety since it prevents “in situ” release of synthesis-derived extraction products.

Grafted Metallic Materials

The process of the invention can be schematically illustrated by FIG. 1.

FIG. 1 clearly illustrates the fact that the process of the invention is “direct” grafting: no intermediate molecule is grafted on the surface of the metallic material to act as “coupler” between the surface of the material and the polymer. In the process of the invention, the polymer is bound to the surface of the metallic material by a single oxygen atom.

Therefore, the grafted metallic materials comprise polymers, preferably bioactive polymers, grafted on the surface thereof.

The grafted metallic materials obtained with the process of the invention advantageously have a contact angle with a water droplet of less than 50°, preferably less than 45°, more preferably less than 30° and advantageously possibly being less than 20°.

The grafted metallic materials obtained with the process of the invention generally have a contact angle with a water droplet larger than 5°.

The inventors have notably discovered that the use of UV irradiation according to the invention allows a major reduction in contact angle to be obtained, compared with non-grafted metallic materials. This discovery allows the envisaging of metallic materials grafted with polymers having small contact angles and hence good biocompatibility.

Advantageously, the process of the invention leads to a grafted metallic material having a grafting rate of said (preferably bioactive) polymer higher than 1.5 μg/cm⁻², preferably higher than 3 μg/cm⁻².

Therefore, the process of the invention leads to a grafted metallic material preferably having a grafting rate of said (preferably bioactive) polymer of between 1.5 and 10 μg·cm⁻², preferably between 3 and 8 μg·cm⁻².

The grafting rate of the polymer is largely a function of exposure time to UV irradiation. It may also depend on the type and amount of monomer used.

The polymers grafted onto the surface of the metallic materials obtained with the process of the invention are derived from radical polymerisation of the above-described monomers used at step b).

The molecular weight of the polymers grafted according to the process of the present invention may vary to a large extent and can be chosen or controlled by skilled persons as a function of the subsequent application or use thereof. Advantageously, the weight average molecular weight of the grafted polymers may vary from 200 to 100 000 Daltons.

Preferably, the polymers grafted on the surface of the metallic materials obtained with the process of the invention are derived from the radical polymerisation of at least one monomer selected from among: acrylic acid, methacrylic acid, methyl methacrylate (MMA), N-(sodium phenylsulfonate) acrylamide (NaAS), N-(sodium phenylsulfonate) methacrylamide (NaMS), sodium styrene sulfonate (NaSS), ethylene glycol methacrylate phosphate, vinylbenzylphosphonate (VBP) and ethyl 2-[4-(dihydroxyphosphoryl)-2-oxa-butyl]acrylate (MA154), and mixtures thereof.

As a function of the monomer used, the grafted polymers may be homopolymers or copolymers.

In a first particular embodiment of the invention, the grafted polymers are homopolymers. In this embodiment, a single monomer is used at radical polymerisation step b), said monomer is then preferably an olefin of formula (I), (II) or (III), preferably selected from among sodium styrene sulfonate (the grafted polymer is then polyNaSS) or methyl methacrylate (the grafted polymer is then poly(methyl methacrylate)—PMMA), ethyl 2-[4-(dihydroxyphosphoryl)-2-oxa-butyl]acrylate (MA154) or vinylbenzylphosphonate (VBP).

In another particular embodiment of the invention, the grafted polymers are copolymers. Preferably, the grafted copolymers are obtained by radical polymerisation of at leads two monomers selected from among the olefins of formula (I), (II) and (III) such as defined above. More preferably, the grafted copolymers are obtained by radical polymerisation of at least two monomers selected from among the olefins of formula (I), (V) and (III) such as defined above.

The quantities of olefins of formulas (I), (II) and/or (III) may vary to a large extent and are adapted in particular as a function of the desired properties for the copolymers.

The copolymers grafted according to the process of the present invention can be obtained by radical polymerisation of monomers which, in addition to the monomers of formulas (I), (II) and (III), comprise other monomers of olefin type. The additional olefins may be of any type, advantageously olefins imparting a water-soluble or non-water-soluble nature to the grafted polymers. Preferably, the additional monomers are of water-soluble type, such as olefins comprising a group of sugar type, in particular olefins comprising an ose group such as glucose, glucofuranose, sucrose, fructose, mannose.

In the copolymers comprising an additional monomer, the quantity of monomers of formula (I), (II) and (III) is advantageously greater than or equal to 25%, preferably greater than or equal to 50%, by moles relative to the total number of moles of the monomer units contained in the polymers.

In one preferred aspect of the invention, the grafted polymers are obtained by radical polymerisation of two or three monomers selected from among the olefins of formula (I), (II) and (III) such as defined above.

Preferably, the grafted polymer is PolyNaSS.

Preferably the material is abundantly washed and sterilised prior to implanting.

### Particular Embodiments

In one preferred embodiment, the process of the invention is a process for grafting PolyNaSS polymers onto a metallic material in titanium or titanium alloy (the alloy advantageously being TiAl₆V₄), comprising the following steps:

a) oxidizing the surface of the material in titanium or titanium alloy, leading to an oxidized material, and

b) grafting a PolyNaSS polymer onto the surface of said oxidized material by radical polymerisation of the sodium styrene sulfonate monomer (NaSS), said radical polymerisation comprising an initiation step and a propagation step,

said initiation step being performed by UV irradiation with a UV source applying power onto the surface of the material higher than 72 mW·cm⁻², preferably between 72 mW·cm⁻² and 20 W·cm⁻², preferably between 72 mW·cm⁻² and 226 mW·cm⁻², preferably between 91 mW·cm⁻² and 226 mW·cm⁻², most preferably of about 162 mW·cm⁻²,

preferably, said UV irradiation being conducted for a time of more than 15 minutes and less than 180 minutes, preferably of 120 minutes or less, more preferably of 90 minutes or less,

said process leading to a grafted material.

In this particular embodiment, grafting step b) may comprise the following sub-steps:
b1) contacting the oxidized material in titanium or titanium alloy with sodium styrene sulfonate (NaSS) in an aqueous solution;
b2) UV irradiation of the solution comprising sodium styrene sulfonate (NaSS) and said oxidized material in titanium or titanium alloy with a UV source applying power onto the surface of the material of between 72 mW·cm⁻² and 20 W·cm⁻², preferably between 72 mW·cm⁻² and 226 mW·cm⁻², preferably between 91 mW·cm⁻² and 226 mW·cm⁻², most preferably of about 162 mW·cm⁻².

Alternatively, grafting step b) may comprise the following sub-steps:
b1′) immersing the material in titanium or titanium alloy in sodium styrene sulfonate (NaSS), said sodium styrene sulfonate (NaSS) being essentially pure, leading to an oxidized metallic material coated with sodium styrene sulfonate (NaSS);
b2′) UV irradiation of the oxidized metallic material in an aqueous solution with a UV source applying power onto the surface of the material higher than 72 mW·cm⁻², preferably of between 72 mW·cm⁻² and 226 mW·cm⁻², preferably between 91 mW·cm⁻² and 226 mW·cm⁻², most preferably of about 162 mW·cm⁻².

Preferably, in this embodiment, the process comprises a cleaning step.

It is understood that skilled persons are able to combine all the particular and preferred embodiments of steps a) and b), with the process of this particular embodiment. Therefore, the grafted material obtained with the process of the invention is preferably a material (preferably prosthetic material) in titanium or titanium alloy on the surface of which polymers are directly grafted, preferably polyNaSS, advantageously with a grafting rate higher than 1.5 μg·cm⁻², preferably between 1.5 and 10 μg·cm⁻², further preferably with a grafting rate of between 3 and 8 μg·cm⁻².

The material is preferably washed and sterilised prior to implanting.

Material Able to be Obtained with the Process

The present invention also concerns the metallic materials able to be obtained with the process of the invention.

The metallic materials able to be obtained with the process of the invention are therefore grafted on their surface with polymers, preferably bioactive polymers.

The grafted metallic materials able to be obtained with the process of the invention advantageously have a contact angle of less than 50°, preferably less than 45°, more preferably less than 40°, more advantageously less than 30° and possibly even being less than 20°. The grafted metallic materials obtained with the process of the invention generally have a contact angle with a water droplet larger than 5°.

The grafted metallic materials able to be obtained with the process of the invention have a grafting rate higher than 1.5 μg/cm⁻², preferably higher than 3 μg/cm⁻², preferably of between 1.5 and 10 μg·cm⁻², further preferably of between 3 and 10 μg·cm⁻².

The polymers grafted on the surface of the metallic materials able to be obtained with the process of the invention are derived from radical polymerisation of the above-described monomers.

The molecular weight of the grafted polymers may vary to a large extent and is chosen or controlled by those skilled in the art as a function of the subsequent application or use thereof. Advantageously the weight average molecular weight of the grafted polymers may vary from 200 to 100 000 Daltons.

Preferably, the polymers grafted on the surface of the metallic materials able to be obtained with the process of the invention are derived from radical polymerisation of at least one monomer selected from among: acrylic acid, methacrylic acid, methyl methacrylate (MMA), N-(sodium phenylsulfonate) acrylamide (NaAS), N-(sodium phenylsulfonate) methacrylamide (NaMS), sodium styrene sulfonate (NaSS), ethylene glycol methacrylate phosphate, vinylbenzylphosphonate (VBP) and ethyl 2-[4-(dihydroxyphosphoryl)-2-oxa-butyl]acrylate (MA154).

As a function of the monomers used, the grafted polymers may be homopolymers or copolymers.

In a first particular embodiment of the invention, the grafted polymers are homopolymers. In this embodiment, a single monomer is used for radical polymerisation, said monomer is then preferably an olefin of formula (I), (II), (III) or (IV) such as defined above, preferably selected from among sodium styrene sulfonate (the grafted polymer is then polyNaSS) or methyl methacrylate (the grafted polymer is then poly (methyl methacrylate), or PMMA), Vinylbenzylphosphonate (VBP) or ethyl 2-[4-(dihydroxyphosphoryl)-2-oxa-butyl] acrylate (MA154).

In another particular embodiment of the invention, the grafted polymers are copolymers. Preferably, the grafted copolymers are obtained by radical polymerisation of at least two monomers selected from among the olefins of formula (I), (II), (III) and (IV) such as defined above. More preferably, the grafted copolymers are obtained by radical polymerisation of at least two monomers selected from among the olefins of formula (I), (II) and (III) such as defined above.

The quantities of olefins of formulas (I), (II), (III) and/or (IV) may vary to a large extent and are adapted as a function in particular of the desired properties of the copolymers. The copolymers grafted according to the process of the invention can be obtained by radical polymerisation of monomers which, in addition to the monomers of formulas (I), (II), (III) and (IV), comprise other monomers of olefin type. The additional olefins may be of any type, advantageously olefins imparting a water-soluble nature to the grafted polymers. Preferably, the additional monomers are of water-soluble type, such as the olefins comprising a group of sugar type, in particular olefins comprising an ose group such as glucose, glucofuranose, sucrose, fructose, mannose.

In the copolymers comprising an additional monomer, the quantity of monomers of formula (I), (II), (III) and (IV) is advantageously greater than or equal to 25%, preferably greater than or equal to 50%, by moles relative to the total number of moles of monomer units contained in the polymers.

In one preferred aspect of the invention, the grafted copolymers are obtained by radical polymerisation of two or three monomers selected from among the olefins of formula (I), (II), (III) and (IV) such as defined above.

Preferably, the grafted polymers are PolyNaSS, vinylbenzylphosphonate (VBP) and ethyl 2-[4-(dihydroxyphosphoryl)-2-oxa-butyl] acrylate (MA154).

The material is preferably washed and sterilised prior to implanting.

Uses of the Materials of the Invention

The present invention also pertains to a prosthetic implant produced from the metallic materials able to be obtained with the process of the invention.

The prosthetic implants of the invention are advantageously joint implants, in particular used as hip prosthesis, or dental implants.

The present invention also concerns the implants of the invention for use thereof for joint replacement or tooth replacement, in particular via surgery.

### DESCRIPTION OF THE FIGURES

FIG. 1 schematically illustrates one embodiment of the process of the invention using the different intermediate species involved at each step of the process. Material (1) corresponds to a non-treated prosthetic metallic material having a native oxidation layer on the surface. Material (2) has undergone the oxidation step a) and has hydroperoxide functions on its surface of which the density is equal to or greater than the OH functions of the material in the native state. Material (3) has undergone an initiation step via UV irradiation: homolytic cleavage of the O—O or OH bond has occurred giving rise to O radicals on the surface. This initiated material (3) is then placed in the presence of an olefin of formula CH₂=CR₁A (where for example R₁ represents H, and A represents Ph-SO₃Na), and is subjected to the polymerisation step to lead to the grafted material (4).

FIG. 2 is a bar chart illustrating the effect of oxidation step a) on the grafting rate of a prosthetic material in titanium (Example 3). The Y-axis represents the grafting rate in μg·cm⁻². The left-hand bar (A) represents the mean grafting rate obtained with 6 samples of titanium material after subjection to steps a) and b) of the process of the invention, and the right-hand bar (B) represents the mean grafting rate obtained with 2 samples of titanium material after subjection solely to step b) of the process of the invention (no controlled oxidation, only natural oxidation).

FIG. 3 gives three infrared spectra: spectrum of crude titanium (non-treated prosthetic material i.e. in the native state, top spectrum), spectrum of non-grafted polyNaSS (middle spectrum), and spectrum of a material in titanium grafted with polyNaSS according to the process of Example 1 (bottom spectrum). The Y-axis represents transmittance (in %). The X-axis represents the wave number (in cm⁻¹).

FIG. 4 is a bar chart illustrating the impact of waiting time between the cleaning step and oxidation step. The Y-axis represents the grafting rate in μg·cm⁻². The left-hand bar (A) represents the mean grafting rate obtained for a titanium material subjected to the oxidation step 16 hours after the cleaning step, and the right-hand bar (B) represents the mean grafting rate obtained with a titanium material subjected to the oxidation step 2 hours after the cleaning step.

FIG. 5 illustrates the grafting rate of a metallic material in titanium in Example 4 as a function of UV irradiation time of the oxidized material in 0.32 M monomer solution. The Y-axis represents the grafting rate in μg·cm⁻², and the X-axis represents UV irradiation time in minutes. The values given are mean values over three experiments.

FIG. 6 illustrates the grafting rate of a metallic material in titanium as a function of power per unit area of UV irradiation, for an exposure time of 45 min on a titanium alloy material (FIG. 6A) and on a titanium material (FIG. 6B), in 0.7 M monomer solution. The values given are mean values over three experiments.

### EXAMPLES

The advantages of the present invention will become apparent in the light of the following examples concerning particular embodiments of the invention, but which cannot be construed as being limiting.

### Example 1: Implementation of the Process of the Invention

1.1. Implementation of the Process

The metallic material in this example is a material in titanium or titanium alloy.

1.1.1 Polishing

The surfaces of the metallic material in titanium may first be polished.

Mechanical polishing of titanium discs is performed by means of an automatic arm mounted on a rotating polisher, using grinding paper of decreasing grit size (Struers). First polishing with grade 500 paper (hereafter P500) removes a thickness of about 1/10^{th} millimetre. Polishing is then refined using grade 1200 paper of lesser grit size (hereafter P1200).

The protocol used was the following: the discs were polished 1 to 2 minutes with P500 paper and a rotating speed of 200 rpm, and then 1 to 2 minutes with P1200.

After polishing, the samples were washed by immersion in an acetone solution (overnight), then 2×15 min in acetone in an ultrasonic bath and finally 3×15 min in distilled water in an ultrasonic bath. They were then dried at 60° C. and used immediately or stored under argon.

1.1.2 Cleaning

The polished metallic material was then subjected to a cleaning step in a mixture of H₂O/HF/HNO₃ (88:2:10). The solution used for this washing was a mixture of water, a 24 M aqueous solution of hydrofluoric acid and a 10 M aqueous solution of nitric acid in respective proportions of (88:2:10) (v/v/v), left under agitation for 1 minute. The samples were oven dried at 60° C.

1.1.3 Oxidation

The cleaned metallic material was then subjected to an oxidation step via chemical treatment. The metallic material was immersed in a mixture of concentrated sulfuric acid H₂SO₄ and hydrogen peroxide H₂O₂.

The samples were immersed in a volume v of concentrated sulfuric acid H₂SO₄ (50% dilution in water for the alloy) under agitation for 1 minute. An equivalent volume v of hydrogen peroxide H₂O₂ (30% by volume in water) was added and the samples left in this mixture under agitation for 3 minutes. The oxidized surfaces were then rinsed in 3 baths of water for 3 minutes.

Alternatively, the cleaned metallic material can be subjected to an oxidation step via anodic treatment.

1.1.4 Grafting

Thereafter, the oxidized metallic material is immersed in a degassed aqueous solution of sodium styrene sulfonate monomer (NaSS) at 0.7 mol/L or 0.32 mol/L. The solution in which the oxidized material was immersed was exposed for a time varying between 15 min and 240 min as a function of samples to UV irradiation from a UV source of wavelength 365 nm and 200 W power. As a function of the distance between the lamp and the metallic material (from 5 cm to 30 cm), the power per unit area varied between 72 mW·cm⁻² and 226 mW·cm⁻².

1.2. Characterization:

The presence of the polymers grafted on the surface was measured using different methods.

1.2.1. Toluidine Blue (TB) Colorimetric Method

The grafted metallic samples were placed in contact with a 5.10⁻⁴ M TB solution (adjusted to pH 10 with sodium hydroxide) at a temperature of 30° C. for 6 hours. This step corresponds to TB complexing with the monomer units of the grafted polymer. The samples were then abundantly rinsed with 1.10⁻³M sodium hydroxide solution to remove non-complexed TB. Rinses were halted when the solution became colourless. The complexed TB was decomplexed with 50% acetic acid solution that was left in contact with the titanium samples for 24 hours. The solution obtained was assayed by spectrophotometry using a Perkin Elmer Lambda 25 spectrophotometer (Biomacromolecules 2006, 7, 755-760).

1.2.2. Attenuated Total Reflectance Fourier Transform Infrared Spectroscopy (ATR-FTIR).

The samples were directly analysed (without preparation) by ATR-FTIR on Perkin Elmer Spectrum Two apparatus.

1.2.3. Measurement of Contact Angle

Measurements of contact angles were made on a drop of water deposited on the surface of the oxidized or grafted samples, using KRUSS: DSA100 apparatus providing information on surface changes of hydrophilic or hydrophobic type.

1.3. Results

1.3.1 Validation of Grafting

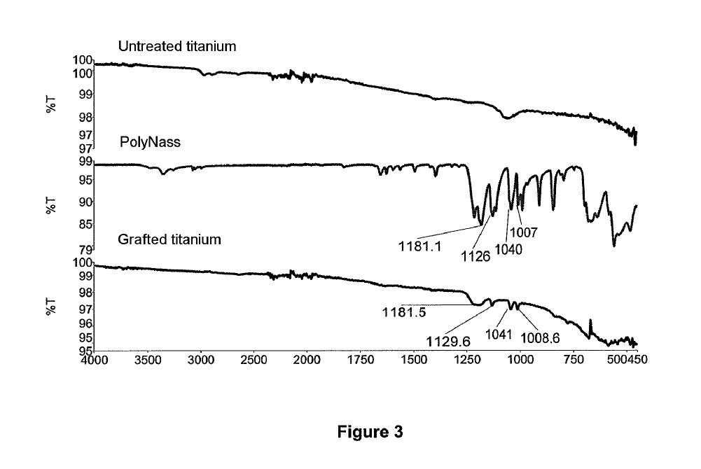

For the samples obtained by implementing the process described under item 1.1., the characteristic bands of the sulfonate group at 1180 cm⁻¹ and 1128 cm⁻¹, and the vibrational doublet at 1010 1040 cm⁻¹, symmetric vibration at 1040 cm⁻¹ were observed in the Attenuated Total Reflectance Fourier Transform Infrared spectrum (ATR-FTIR, see FIG. 3).

1.3.2 Importance of the Oxidation Step

Measurement of the amount of polyNaSS polymers grafted on the surface of the titanium was carried out by complexing the sulfonate groups of the polymers with Toluidine Blue both on those samples that had been subjected to the process described under item 1.1 (e.g. polishing, cleaning, oxidation), and on samples of metallic material that had not been subjected to an oxidation step (e.g. only polishing and cleaning).

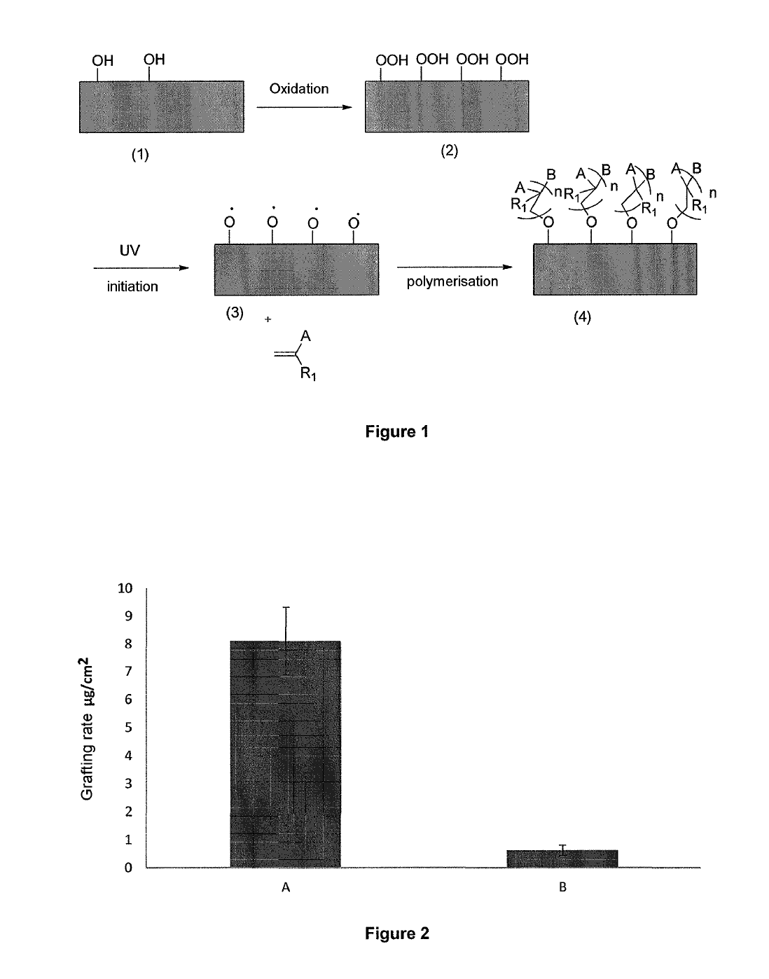

Therefore, for the samples subjected to the entirety of the process described under item 1.1., a grafting rate in the order of 8 μg/cm² was observed (see FIG. 2) whereas the samples not subjected to the controlled oxidation step displayed a grafting rate of 0.62 μg/cm⁻².

Oxidation of the metallic material via chemical oxidation as well as anodic oxidation gave satisfactory results.

It is to be noted that a sample of material in oxidized titanium immersed in a solution of polyNaSS (e.g. Acros, Mn=70000 g/mol, batch N^{o}: A012503701, CAS: 24704-18-1) at a concentration of 0.7 mol/L then abundantly washed by rinsing in water, but not subjected to a grafting step properly so-called, gives values of 0.3 μg/cm² when measured by complexing with Toluidine Blue. This experiment allows the hypothesis to be set aside according to which the polymer is merely adsorbed on the surface of the oxidized metallic material (e.g. titanium).

To conclude, the oxidation step is essential to obtain a grafted metallic material according to the invention. It allows the grafting rate to be increased by a factor of 25 (7.7 vs. 0.3 μg/cm) compared with grafting on a metallic surface having natural oxidation.

1.3.3. Measured Properties

On “pure” titanium material (i.e. non-grafted starting titanium i.e. not having undergone the process of the invention) the contact angle is 59±5°.

The samples of grafted material obtained with the process described under item 1.1. have a contact angle of 15±2°, i.e. a decrease in the contact angle of 44° between the non-treated surface and the grafted surface.

To conclude, the grafted metallic materials obtained with the process of the invention have a much more hydrophilic surface than non-grafted metallic materials, and this is particularly made possible by the prior oxidation step.

### Example 2: Importance of the Time Between Cleaning and Oxidation

2.1. Protocol

The metallic material in this example is a material in titanium. 15 samples of said metallic material were used.

The surfaces of the 15 samples of titanium metallic material were first polished and then cleaned in a mixture of H₂O/HF/HNO₃ (88:2:10).

The cleaned 15 samples were then subjected to an oxidation step.

After a waiting time varying from 2 hours to 16 hours, the 15 oxidized samples were subjected to the grafting step in an aqueous solution of sodium styrene sulfonate monomer (NaSS).

The other conditions used were identical to those described in Example 1.

2.2. Results

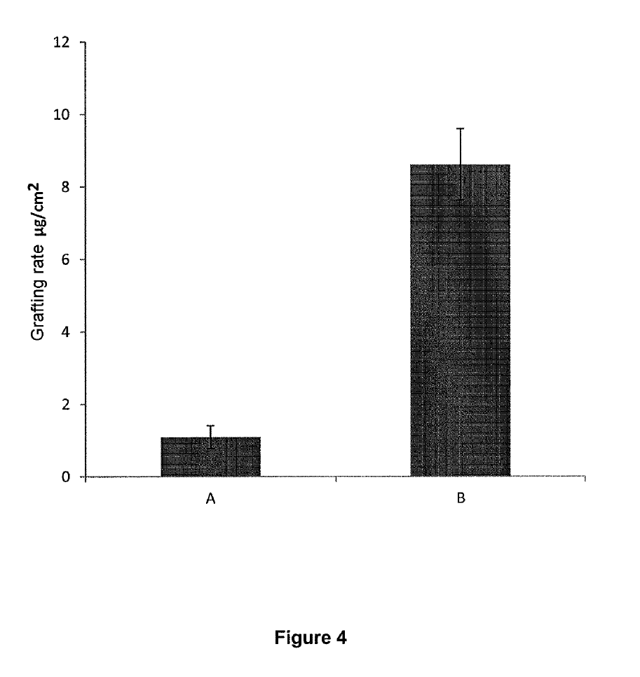

FIG. 4 shows that the time between the end of cleaning and the start of oxidation is of importance regarding the grafting rate of the method of the invention.

if a time of 16 hours or more separates the end of the cleaning step and the start of the oxidation step, the grafting rate is not optimal (e.g. 1.09 μg/cm⁻²).

It is therefore preferable to carry out the oxidation step fairly rapidly after the cleaning step.

### Example 3: Influence of Irradiation Time on Grafting Rate

3.1. Protocol

The metallic material in this example was a material in titanium.

15 samples of said metallic material were used.

The surfaces of the 15 samples of titanium metallic material were first polished.

The 15 samples were then cleaned in a mixture of H₂O/HF/HNO₃ (88:2:10).

Thereafter, the 15 cleaned samples were subjected to an oxidation step via chemical treatment.

The 15 oxidized samples were subjected to the grafting step in an aqueous solution of sodium styrene sulfonate monomer (NaSS).

The other conditions used were identical to those described in Example 1.

3.2. Results

The grafting rate of polyNaSS on the surface of the 15 samples of titanium was examined by complexing the sulfonate groups of the polymers with Toluidine Blue.

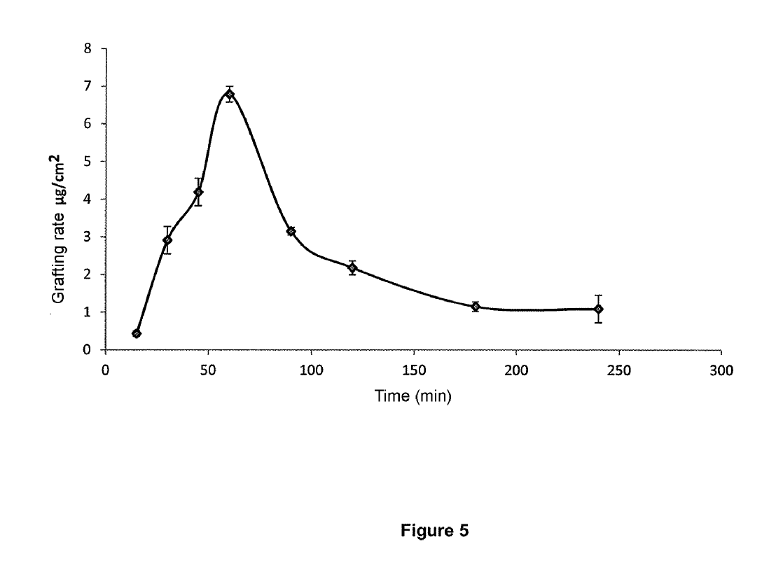

The results given in Table 1 and FIG. 5 show that the optimal results i.e. a grafting rate higher than 1.5 μg/cm⁻², were obtained in this case with UV irradiation of between 30 and 120 minutes.

TABLE 1

| Time (min) | Mean (μg · cm⁻²) |
|---|---|
| 15 | 0.43 |
| 30 | 2.91 |
| 45 | 4.19 |
| 60 | 6.79 |
| 90 | 3.15 |
| 120 | 2.18 |
| 180 | 1.15 |
| 240 | 1.09 |

### Example 4: Influence of Power Per Unit Area of UV Irradiation on Grafting Rate

4.1. Protocol

The metallic material in this example was material in titanium or titanium alloy.

15 samples of said metallic material were used.

The surfaces of the 15 samples of metallic material in titanium or titanium alloy were subjected to a cleaning step.

The 15 cleaned samples were subjected to an oxidation step.

The 15 oxidized samples were then immersed in an aqueous solution of sodium styrene sulfonate monomer (NaSS).

The solution in which the oxidized material was immersed was exposed for 45 min at distances varying between 5 centimetres and 30 centimetres to UV irradiation from a UV source of 200 W and wavelength 365 nm, the power per unit area therefore varying between 72 mW·cm⁻² and 226 mW·cm⁻².

The other conditions used were identical to those described in Example 1.

4.1. Results

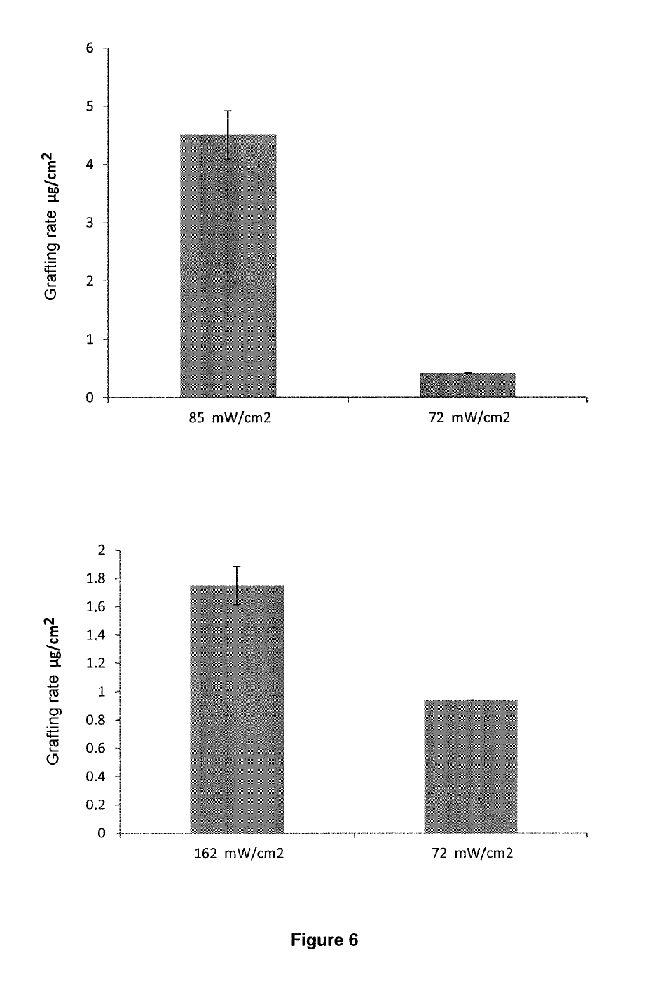

FIG. 6 shows that power per unit area higher than 72 mW·cm⁻² is needed to allow satisfactory grafting on the metallic material.

1. Process for direct grafting of bioactive polymers onto a prosthetic metallic material in titanium or titanium alloy, comprising the following steps:
a) oxidizing the surface of the metallic material, leading to an oxidized surface of metallic material;
b) grafting a polymer on the oxidized surface of said metallic material, by radical polymerisation of a monomer placed in the presence of the oxidized surface of the metallic material, said radical polymerisation comprising an initiation step and a propagation step,
said initiation step being performed by UV irradiation with a UV source applying power onto the surface of the material higher than 72 mW·cm⁻²,
said UV irradiation being performed for a time of more than 30 minutes and less than 180 minutes,
said process leading to a prosthetic metallic material in titanium or titanium alloy grafted with bioactive polymers.

2. The process according to claim 1, wherein said initiation step is performed by UV irradiation with a UV source applying power of between 72 mW·cm⁻² and 20 W·cm⁻².

3. The process according to claim 1, wherein said initiation step is performed by UV irradiation with a UV source for a time of 90 minutes or less.

4. The process according to claim 1, wherein said initiation step is performed by UV irradiation with a UV source applying power of between 72 mW·cm⁻² and 260 mW·cm⁻².

5. The process according to claim 1, wherein said initiation step is performed without heating in addition to UV irradiation.

6. The process according to claim 1, wherein the concentration of monomer(s) in the solution is between 0.2 and 1 mol·L⁻¹.

7. The process according to claim 1, wherein the metallic material is an alloy of titanium with nickel, vanadium, aluminium, niobium, and/or molybdenum.

8. The process according to claim 1, wherein said monomer is an olefin.

9. The process according to claim 1, wherein the monomer is sodium styrene sulfonate (NaSS).

10. The process according to claim 1, wherein the monomer is selected from among sulfonates, phosphonates and/or carboxylates.

11. The process according to claim 1, wherein said radical polymerisation is conducted in the absence of oxygen.

12. The process according to claim 1, wherein the initiation step is performed prior to or concomitantly with the propagation step.

13. The process according to claim 1, wherein it comprises a cleaning step performed prior to the oxidation step, the time between the end of the cleaning step and the start of the oxidation step being less than 16 hours.

14. The process according to claim 1, wherein the oxidation step a) is performed by treating the material with an aqueous solution comprising an oxidant and an acid.

15. The process according to claim 1, wherein the oxidation step a) is performed by anodic treatment.

16. The process according to claim 1, wherein the grafted metallic material has a grafting rate of said polymer higher than 1.5 μg·cm⁻².

17. The process according to claim 1, characterized in that said initiation step is performed by UV irradiation with a UV source for a time equals or less than 120 minutes.

18. The process according to claim 7, characterized in that said metallic material is the alloy TiAl₆V₄.

19. The process according to claim 10, characterized in that the monomer is selected among acrylic acid, methacrylic acid, methyl methacrylate (MMA), N-(sodium phenylsulfonate) acrylamide (NaAS), N-(sodium phenylsulfonate) methacrylamide (NaMS), ethylene glycol methacrylate, methacrylate phosphate, methacryloyl-di-isopropylidene, vinylbenzylphosphonate (VBP), ethyl 2-[4-(dihydroxyphosphoryl)-2-oxa-butyl]acrylate (MA154), or mixture thereof.

20. The process according to claim 16, characterized in that the grafted metallic material has a grafting rate of said polymer higher than 3 μg·cm⁻².
